(19) United States
(12) Patent Application Publication
(10) Pub. No.: US 2020/0291684 A1
(43) Pub. Date: Sep. 17, 2020

(54) MULTI-PURPOSE BIOMETRIC LOCKING ASSEMBLY

(71) Applicants: Jonathan Kinas, Aventura, FL (US); Robert Peck, Ganesvoort, CT (US); Avin Samtani, Miami Beach, FL (US)

(72) Inventors: Jonathan Kinas, Aventura, FL (US); Robert Peck, Ganesvoort, CT (US); Avin Samtani, Miami Beach, FL (US)

(73) Assignee: Aquavault LLC, Aventura, FL (US)

(21) Appl. No.: 16/352,257

(22) Filed: Mar. 13, 2019

Related U.S. Application Data
(63) Continuation-in-part of application No. 29/683,450, filed on Mar. 13, 2019.

(51) Int. Cl. E05B 47/00; G07C 9/00; E05B 63/00; G06K 9/00

(52) U.S. Cl. CPC E05B 47/0012; G07C 9/00944; G06K 9/00013; G07C 9/00563; E05B 63/0056

(57) ABSTRACT

A multi-purpose biometric locking .system is provided having interchangeable cables and a biometric lock. The locking system includes multiple length locking cables that are interchangeable in the locking system and include differing lengths and diameters for use in a variety of desired situations. The locking system also includes a biometric sensor to allow the lock to be operated using the fingerprints of the approved users.

### BACKGROUND OF TOE INVENTION

### 1. Field of the Invention

The present invention is generally directed to a multi-purpose biometric locking system having interchangeable cables and a biometric lock. As described herein, the locking system includes multiple length locking cables that are interchangeable in the locking system. The locking system also includes a biometric sensor to allow the lock to be operated using the fingerprints of the users.

### 2. Description of Related Art

A variety of locks for numerous different functions have been disclosed in the art. A group of these locks include electronic or biometric features that provide the added convenience of being usable without the need for a key or other mechanical mechanism for opening the lock.

As disclosed in U.S. Patent Application No. US 2003/0016847, a microprocessor operated keyless entry padlock is disclosed. This disclosure describes a fingerprint sensor for reading a fingerprint and comparing it to at least one fingerprint stored in the memory of the padlock. If a match is found, the padlock may be manually opened by a knob or is automatically opened by operating a drive gear portion connected to a locking bar to open the padlock.

As disclosed in U.S. Patent Application No. US 2007/0126551, a padlock is disclosed having a body and a shackle having two ends, one end of the shackle being rotatably secured within the body, the other end of the shackle being releasable from the body when the padlock is unlocked. The padlock comprises a biometric interlace disposed in a bottom wall defined in a base of the body. The interface includes a fingerprint scanner and a user access interface. A biometric validation module is disposed within the hotly and communicated to the biometric interface for processing a biometric profile from the fingerprint Scanner and for indicating a status with the user access interface. The biometric validation module provides a lock control signal responsive to processing of the biometric profile; and a mechanical interface, coupled to the biometric validation module and to a latch, for controlling a mode of the padlock responsive to a lock control signal from the biometric validation module, the mode including the unlocked mode in which the latch releases the shackle and the locked mode wherein the larch retains the shackle within the body when the shackle is inserted into the body,

U.S. Pat. No. 8,353,187 granted to Wood ling discloses a keyless padlock system that includes an electromagnetic switch system, a combination code and a fingerprint process system. The switch system and fingerprint process system operate a conventional clasp member which is movable between open and closed positions. The electromagnetic switch system operates the padlock with a mechanical actuated mechanism. The fingerprint process system allows the padlock device to operate similar to a key system. The buttons and LED's manage the padlock device using both fingerprint and a combination code. A changeable battery system is utilized without losing tire memory to provide a padlock device that is reliable and easily programmed.

### SUMMARY OF THK INVENTION

Briefly and in general terms, the present invention provides a new and improved system and method for using a fingerprint and identification system for use with a multipurpose locking device.

It is a particular object of the present invention to have an improved cable system that includes a plurality of interchangeable cables that arc adapted for use in a variety of different situations. For example, a three-cable system may he provided wherein cable 1 may he a travel sized cable for use with luggage, zippers, bags, etc. Cable 2 may be a heavier duty cable for lockers, fences, storage units and heavy-duty applications. Cable 3 may be a longer heavy-duty cable for use with bikes, skis/snowboards, equipment etc.

It is still another particular object of the present invention to provide a fingerprint identification switch system connected with an actuated mechanical operation system to the locking device. More particularly, in an embodiment of the present invention, the locking device is provided with one or more LED buttons and a USB element for operating the fingerprint management. The LED on the buttons indicates the operation and the battery status without loss of the memory of fingerprint installed. It is a further object of the present invention to have both administrative, user and manufacturing access though the fingerprint microprocessor system to the locking system.

### BRIEF DESCRIPTION OF THE DRAWINGS

FIG. 1 is a perspective view of locking system of the present invention showing the front and side of the locking system.

FIG. 2 is a front view of locking system of the present invention showing the front side of the locking system with multiple length and varied thickness cable structures of the preferred embodiment.

FIG. 3 is side view of locking system of the preferred embodiment.

FIG. 4 is a bottom view of the locking system of the preferred embodiment.

FIG. 5 is a perspective view of locking system of an alternate embodiment showing the from and side of the locking system.

FIG. 6 is a side view of the alternate embodiment of the locking system.

FIG. 7 is a front view in cross section of the locking system of the preferred embodiment of the locking system.

FIG. 8 is a side view in cross section of the locking system of the preferred embodiment.

FIG. 9 is a flow diagram of the installation of the user fingerprints, and instructions for the operation of the locking system of the present invention.

FIG. 10 is a schematic of the operation of the locking system of the preferred embodiment.

### DETAILED DESCRIPTION OF PREFERRED EMBODIMENTS

The present invention is directed to an improved system and method for providing a user with an improved multi-purpose locking system having the features of a traditional padlock. The preferred embodiments of the improved system and method are fully detailed, illustrated and described herein.

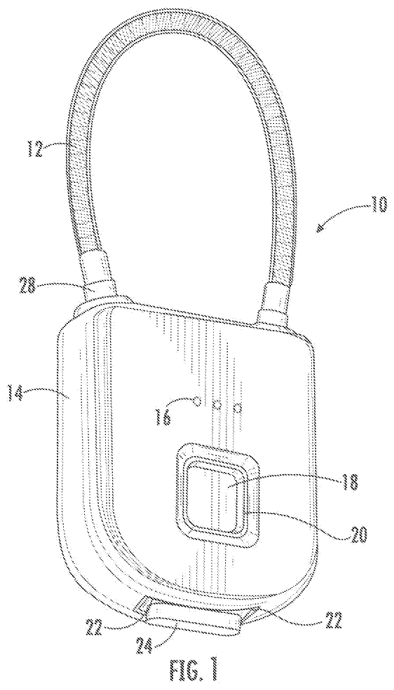

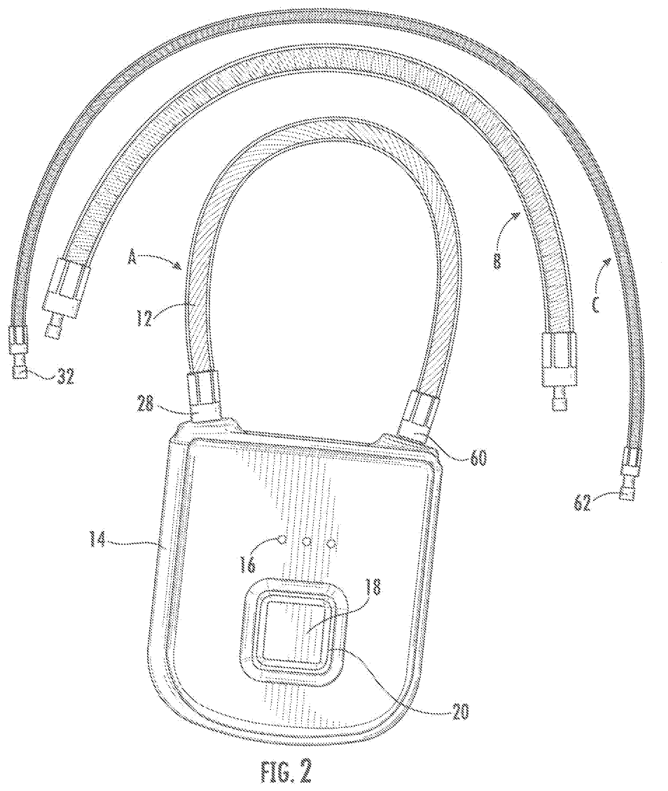

As shown in FIG. 1, the present invention relates to a biometric locking system 10 having a cable member 12 that is retained in a locked position within the housing 14 of the locking system. As shown in FIG. 2, a three-cable system may be provided wherein cable A may be a shorter, travel sized cable for use with luggage, zippers, bags. etc. Cable B may be a medium length heavier duty cable for lockers, fences, storage units and heavy-duty applications. Cable C may be a longer heavy-duty cable for use with bikes, skis/snowboards, equipment etc.

The front surface of the housing 14 has at least one LED 16 indicator to indicate the status of the locking system 10 for the fingerprint installation and system management. The user uses the LED 16 to control and manage the locking system 10 with the set-up provided from a software program or microprocessor 46. The user can install and manage the fingerprint storage by following the LED 16 colors and indications.

The fingerprint sensor 18 is shown at the front surface of the locking system 10 in figure 1 and FIG. 2. The user may use any desired finger to press the finger into the recess on the sensor frame 20 to install the initial fingerprint data into the locking system 10 or open the locking system 10. The location of the fingerprint sensor 18 provides a safe position for applying the fingerprint of the user to avoid inadvertent contact and to provide a convenient operational position for the user to place their finger on the sensor 18.

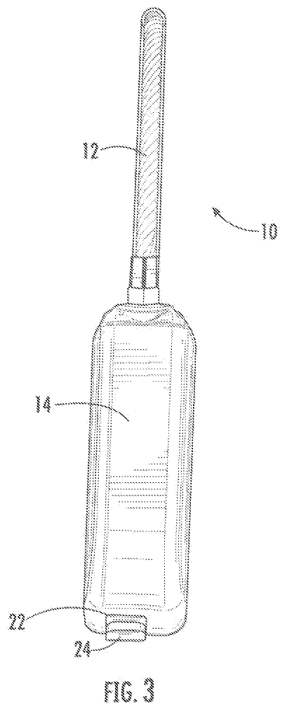

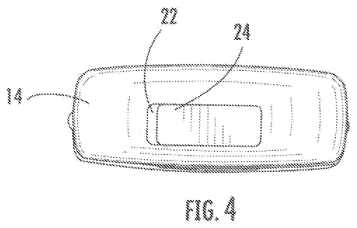

On the bottom surface of the locking system 10 of the present invention show n in FIG. 3 and FIG. 4, there is USB opening 22 for providing access to the locking system with a USB connector 24 which is inserted into the bottom of the housing 14. A battery 26 is located inside of housing 18 and is preferably rechargeable through the use of the USB connector 24 or an optional solar panel 56. Alternately, the battery 26 may he exchanged without affecting the existence of previously stored fingerprint data.

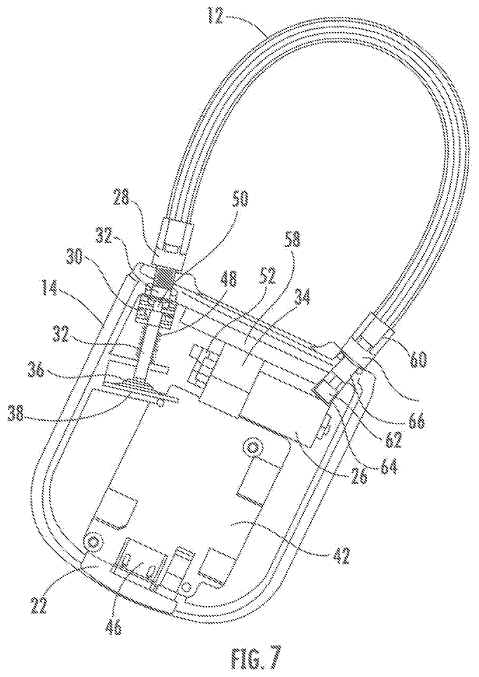

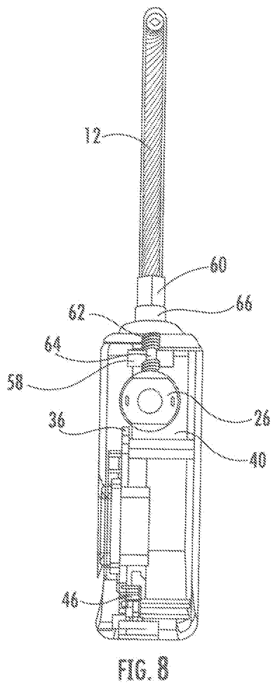

The cable post 28 of the cable member 12 is shown in FIG. 7 and FIG. 8. The cable post 28 is shown as being held in the inner locking recess 30 of the housing 14. The cable post 28 may be spring biased and/or of any desired shape, such as a U-shaped, recessed or with an extending element 32. The extending element 32 is preferably attached to or formed on the cable post 28 as described more fully below. Upon actuation of a knob or motor 34. as described below, the drive gear 36 may be rotated to turn gear portion 38, to release the cable post 28 from the closed or locked position, to allow the user to open the locking system 10. The drive gear 36 may be directly connected between a drive shaft of a knob or motor 34 and gear portion 38. The drive gear 36 may be connected to intermediate gears or a gear reducer. A knob (not shown) may also be manually actuated to open the locking recess and release the cable post 28. If an electrical motor is used, it must be sized and dimensioned to fit within the housing in the locking system 10 and have sufficient torque to open the locking member under worst case power availability and temperature conditions. At the same time, the motor must be capable of being operated at low power so as not to quickly drain the power battery or other power source.

As shown in FIGS. 1, 2 or 6, a fingerprint sensor 18, which may be of any known type, such as a capacitive, optical or thermal, is secured in a pre-selected area and electrically connected to a circuit board 42 having a power source 26, such as one or more batteries, between the front and back surfaces of the housing 14. The fingerprint sensor 18 is directly connected to a microcontroller or microprocessor 46 held on the circuit board 42. When an authorized fingerprint is detected or sensed by fingerprint sensor 18, a signal is sent to the microprocessor 46. In response to the generation of a signal, a motor 34 is actuated by the power source 26 to rotate and release the cable post 28 by means of the gear drive 36 and gear portion 38 or a knob that is released and turned, as explained below, Before the knob is turned or the motor 34 may operate, a latch arm or lever 50 is actuated by a solenoid 52, to release the holding element on gear 36. The latch 50 may include a spring 48 held between the front and back surfaces to bias the latch in a closed position. The mechanism may be designed so that the motor may only unlock or release the cable post 28, whereby a user must manually close or open the locking system 10 by removing or inserting the cable post 28 into or from the locking recess 30. A secondary sensor 58 is mounted adjacent the latch 50 to sense if the latch is in the open or closed position. The fingerprint sensor 18 is preferably mounted behind or protected by a window or the like and the sensor frame 20 is secured to the front surface of the housing 14. Additionally, to save power, when in a standby mode, tire circuit is designed to draw nearly zero current. Therefore, when it is desired to open the lock, it is preferable to have a sensor that is pressed or activated to start the power-up process. An authorized user may then pass their finger across window of the sensor frame 20 to have their fingerprint read to activate the motor 34 or allow the knob to be turned to open the locking system 10.

An alternate locking mechanism which is primarily electromagnetic may also be used with the present invention. The mechanism of the electromagnetic switch system of the locking system 10 of the present invention includes a rod that is assembled to a major electromagnetic switch that is retracted into the solenoid 52 and a magnetic body when the unlocking signal is turned on. The magnetic body holds the rod until the locking signal pushes the rod back to the locking position. A minor electromagnetic switch is used to retract the rod to the solenoid body and pull a stop plate back to squeeze a spring following the rod after receiving the unlocking signal. The rod and the slop plate will be released by the spring after the off signal is received. The minor electromagnetic switch works before the major electromagnetic switch is activated. The microprocessor 46 controls the signals in the fingerprint processing system.

The preferred form of this alternate locking system includes an internal structure at the locking and unlocking position of the cable post 28 of the present invention. The electromagnetic switch system works by receiving an on or off signal from microprocessor 46. When the unlocking signal is on, an end cap will follow the rod. The rod then slides off the sliding block with an end spring. The sliding block with the end spring is moved free from the cable post 28. The user can then pull the cable member 12 tree from the housing 14 to open the locking system 10.

When the user pushes the cable post 28 into the housing 14 as a normal lock to lock the locking system, the return block with the return spring acts as a return switch to provide a locking signal to push the rod back to the locking position. The sliding block is then pushed by cable post 28 and spring back to the locking position. The sliding block with the end spring preferably has a 90-degree motion with respect to the cable post 28. When the extending element 32 on the cable post 28 is blocked by the sliding block with the end spring, the locking system 10 w ill be locked. When the extending element 32 of the cable post 28 has not been blocked by the sliding block with the end spring, the cable post 28 can be moved up and down in the locking recess 30. In this embodiment, the user is able to pull or push the cable member 12 and cable post 28 to unlock or lock the locking system 10.

As shown in FIG. 2, the cable system of the present invention includes cable members 12 of varying length, size and diameter shown as Cables A, B or C. As described herein, the cable members 12 may be used in the locking system 10 to secure multiple different objects. The cable member 12 preferably includes a strong, flexible cable section 60 that is preferably not easily cut. The cable member 12 includes the cable post 28 with the extending element 32 thereon. The other end of the cable member 12 preferably includes a secondary post member 62 that is retained in a secondary locking member 64 of the locking system 10. The secondary post member 62 includes an extension or similar member that is releasably retained in the secondary locking member 64. When the locking system 10 is in the locked configuration, the secondary post member 62 is retained in the secondary locking member 64 of the locking system 10. When the locking system 10 is in the unlocked configuration, the secondary post member 62 is releasable front or insertable into the secondary locking member 64. In this form of the invention, the secondary post member 62 is releasable from the secondary locking member 64 upon actuation by the secondary sensor 58. Bach of the cable members 12 preferably include standardized cable posts 28 and secondary post members 62 to allow the various cable members to be interchangeable with the locking system 10. This versatile feature allows the user to select the desired length and thickness of the cable member for the intended use. In an alternate or additional feature of this embodiment, the secondary post member 62 may be fixedly retained in the secondary locking member 64 and a threaded portion 66 may be located on the cable section 60 adjacent to the secondary post member 62 to allow the user to threadedly remove the cable section 60 from the secondary post member 62. The cable section 60 of this embodiment is then interchangeable to allow the user to select the desired length and diameter for the intended use. It is preferable that the threaded portion 66 is not accessible or utilized while the locking system 10 is in the locked configuration as determined by a component such as the secondary sensor 58. In this embodiment, the threaded portion 66 may not be rotated to release the cable member when the other end of the cable is locked in the housing 14.

Turning to FIG. 3 and FIG. 8. the USB access port 22 of the locking system 10 is shown. The USB connector 24 is accessible through the access port in the bottom surface of the housing 14. When the locking system is connected to a computer via the USB connector 24, the microprocessor 46 may be updated, the saved fingerprints may be cleared or updated and/or the batteries 26 may be recharged.

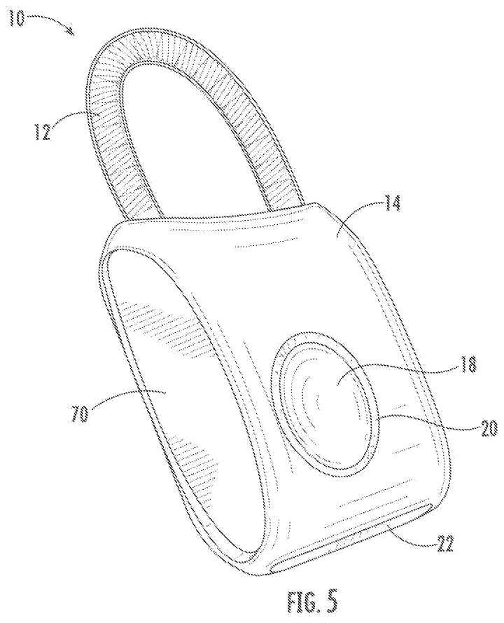

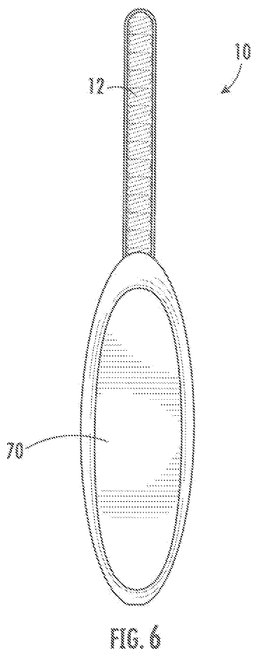

An alternate embodiment of the present invention is shown in figures 5 and 6. In this embodiment, the locking system 10 includes one or more cable members 12, a housing 14 and fingerprint sensor 18. This embodiment includes one or more gripping surfaces 70 located along the sides of the housing 14. In this embodiment, the sides of the housing 14 are preferably slightly recessed such that the user may easily grasp the locking system to place their index finger on the fingerprint sensor 18. The gripping surface 70 may be formed of a rubber material or similar materials to provide a durable surface along the sides of the housing 14 and may include a plurality of raised horizontally aligned members to facilitate the grasping of the sides of the locking system.

When a user's fingerprint is sampled, the details of the fingerprint are extracted and stored in memory as a data set. In the preferred form of the present invention, up to 10 fingerprints may be stored in the microprocessor 46. If the design allows only for one data set to be stored, then each time a fingerprint is stored in record mode it erases the previous set. To record multiple fingerprints for more than one authorized user, each user may be required to follow the steps set forth below. This assures that previously stored data sets are not inadvertently erased. If memory capacity allows for multiple fingerprints to be stored, then the microcontroller firmware may be programmed such that the oldest stored fingerprint set is replaced with the newest fingerprint over a preset amount. Alternately, an administrator fingerprint retained in storage and the secondary fingerprints are selectively deleted. For example, if memory was provided for up to 10 fingerprint data sets, when the 11th fingerprint is recorded, it will overwrite the first non-administrator fingerprint, A small amount of memory is allocated to keep track of the order of the data sets in a format such as a circular buffer or flash memory 72. A mode may be provided which will allow an authorized user to erase all fingerprints stored in the memory. For example, if the user first placed their linger on the fingerprint sensor, this could store the new fingerprint details, leaving the previously stored data alone.

An example of programming the locking system 10 of the present invention includes programming the fingerprint of an administrator and then multiple secondary users. In this embodiment, the administrator presses the finger print sensor for an extended duration. When a blue light is illuminated, the finger is lifted. When a green light flashes, the finger is pressed against the sensor up to ten times while the blue and green light flash. If the storage of the finger print individual application is successful, a blue light flashes. If the finger print individual finger print storage is unsuccessful, a red-light flashes. When ten successful recordings have been stored, a tone is heard and a green light flashes continuously.

For secondary users, the process for recording the finger print involves pressing the finger against the fingerprint sensor for an extended duration until a blue light flashes continuously. The recording of the secondary finger print is then started when the green light flashes. The finger is applied to the sensor ten times as the blue light and green light flash. If the application of the finger is successful, the blue light flashes. If the recording of the application of the finger is unsuccessful, the red-light flashes. When there a total of ten successful recordings of a single fingerprint, a tone is heard and the green light flashes continuously.

Fingerprints may be deleted only by the administrator in one embodiment of the present invention. In this embodiment, the administrator places their finger on the fingerprint sensor for an extended duration. When the red-light flashes continuously, the administrator fingerprint is recognized. The administrator may then delete the secondary fingerprints individually or all stored secondary fingerprints at the same time. The preferred form of the fingerprint sensor allows for at least 180 degree or 270 degree fingerprint recognition. The resolution is preferably about 508 DPI. The battery is preferably 3.7V 300 mAh. The charger may be 5V and 1A. When the voltage is less than 3.5V, the red-light indicator will flash and then an alarm will sound every minute.

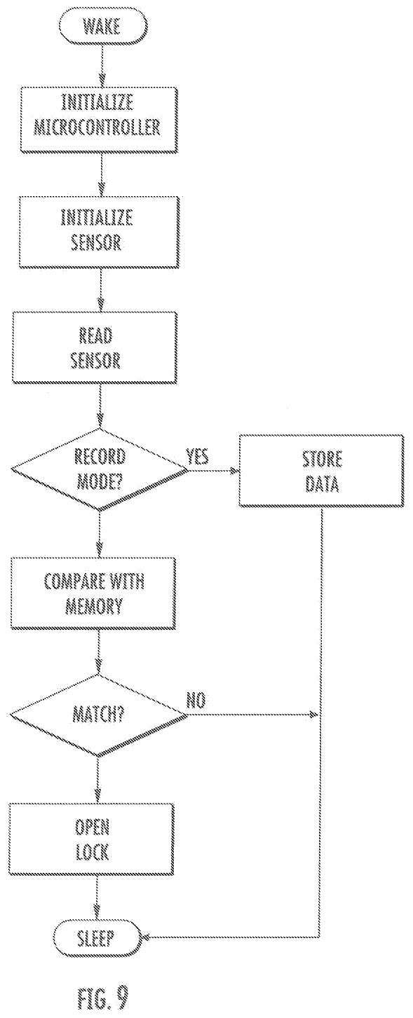

FIG. 9 is a flow diagram of the operation of the electronics of the device of the present invention. After one or more fingerprints have been stored in the locking system 10, the locking system 10 is operated as described below. The sensor frame 20 is initially pushed or activated to provide a wake signal to the circuitry. As a finger is passed over the fingerprint sensor 18; the microcontroller or microprocessor 46 is initialized. The microprocessor 46 will then send out the required control signals to activate the fingerprint sensor 18 and will read data from the fingerprint. The data will then be analyzed to determine if a valid fingerprint has been read. Several attempts will be made to read a valid fingerprint and if a valid print is read, the cable post 28 will be releasable from the locking recess 30 and the locking system 10 will be opened. Alter the locking system 10 is opened, the circuit will return to the sleep mode.

The electronics of the present invention may be programmed whereby if the system is run too many times, or receives too many false fingerprint readings, the locking system 10 may enter into an un-interruptible mode to prevent tampering. Once in the uninterruptible mode, the locking system 10 would then have to be actuated by USB connector 24, so as to be again capable of being actuated by use of the fingerprint Sensor 34. Alternately, a time out configuration may be provided. When the locking system 10 is in the record mode or set to receive new fingerprints, the data will be stored for later comparison.

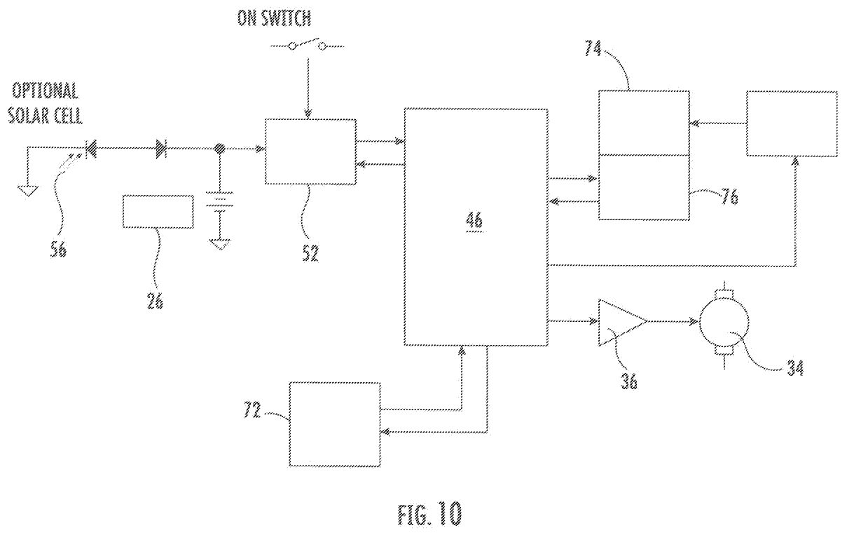

FIG. 10 illustrates a block diagram of the locking system 10 of the present invention having a motor 34. The microprocessor 46 contains the logic necessary for reading the data from the fingerprint sensor 18 and determining when to open or lock the locking system 10. The power supply or battery 26 may be charged by an optional solar panel 56 and an associated power control circuit to ensure that the battery 26 is not discharged during the standby mode. The fingerprint sensor 18 is connected to the microprocessor 46 through a conventional signal conditioning mechanism and data conversion mechanism. The output from the microprocessor 46 runs the motor 34 to the driver or drive gear 36. An optional flash memory 12 may be used to store fingerprint patterns indefinitely, even when battery power is low or lost. Similarly, the optional solar panel 56 may be utilized to provide power to the locking system 10.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A lock comprising;
a housing having first and second recesses therein:
an elongate cable member having a first end and a second end wherein the first end of the cable member is releasably received in the first recess;
a locking mechanism in the housing which is movable between locked and unlocked positions and wherein the locking mechanism engages the first end of the cable member in the first recess in the locked position and the first end of the cable member is releasable from the locking mechanism in the unlocked position; and
the second end of the cable member is separable from the housing in the unlocked position of the locking mechanism.

2. The lock of claim 1 wherein the second end of the cable member is unthreadable from at least a portion of the cable member when the locking mechanism is in the unlocked position.

3. The lock of claim 1 wherein the second end of the cable member is releasable from the second recess when the locking mechanism is in the unlocked position.

4. The lock of claim 1 wherein the first end of the cable member and the second end of the cable member are releasable from the housing when the locking mechanism is in the unlocked position.

5. The lock of claim 4 wherein the locking mechanism is a biometric lock.

6. The lock of claim 5 wherein the biometric lock stores multiple fingerprint scans in a microprocessor positioned in the housing.

7. The lock of claim 6 wherein the locking mechanism unlocks at least the first end of the cable member when the microprocessor matches a fingerprint with a stored fingerprint.

8. The lock of claim 1 wherein the cable member is interchangeable with a cable member having a different diameter.

9. The lock of claim 1 wherein the cable member is interchangeable with a cable member having a different length.

10. A lock, comprising:
a housing having first and second recesses therein;
an elongate cable member having a first end and a second end wherein the first end of the cable member is releasably received in the first recess;
a locking mechanism having a biometric sensor in the housing which is movable between locked and unlocked positions and wherein the locking mechanism engages the first end of the cable member in the first recess in the locked position and the first end of the cable member is releasable from the locking mechanism in the unlocked position in response to actuation of the biometric sensor: and
the second end of the cable member is separable from the housing in the unlocked position of the locking mechanism.

11. The lock of claim 10 further comprising: a fingerprint user interlace which is operable whether the locking mechanism is in a locked position or an unlocked position and including a fingerprint sensor;
a LED tor indication of fingerprint installation, locking status, power on/off status or low battery status;
a memory storage device for storing registered fingerprints;
a microprocessor for comparing the input fingerprint with stored fingerprints; and
a user interface software operation system.

12. The lock of claim 11 wherein
An unlocking signal is applied to an electromagnetic switch if the input fingerprint matches the stored fingerprints in the memory; then after a predetermined amount of time, an unlocking signal is applied to an electromagnetic switch as well;
a locking signal is applied to an electromagnetic switch when a return switch is pushed down by first end of the cable member in the first recess; and
a locking or unlocking signal is turned off after a predetermined time to save energy.

13. The lock of claim 10 wherein a solar panel is provided as a source of power for the microprocessor.

14. The lock of claim 11 wherein
additional fingerprint can be installed and stored after an administrator fingerprint has been verified; and the stored fingerprint can be deleted after an administrator fingerprint has been verified.

15. A versatile lock system comprising:
a housing having first and second recesses therein:
a plurality of elongate cable members each having a first end and a second end wherein the first end of each of the cable member is releasably receivable in the first recess of the housing;
a locking mechanism having a biometric sensor in the housing which is movable between locked and unlocked positions and wherein the locking mechanism engages the first end of the cable member in the first recess in the locked position and the first end of the cable member is releasable from the locking mechanism in the unlocked position in response to actuation of the biometric sensor, and
the second end of each of the cable members is separable from the housing in the unlocked position of the locking mechanism.
